(19) United States
(12) Patent Application Publication
(10) Pub. No.: US 2012/0138237 A1
(43) Pub. Date: Jun. 7, 2012

(54) APPARATUS AND METHOD FOR DELAMINATING ADHESIVE FILM

(76) Inventor: Takaaki Hirano, Osaka-shi (JP)

(21) Appl. No.: 13/389,650

(22) PCT Filed: May 7, 2010
(86) PCT No.: PCT/JP2010/003138

§ 371 Date: Feb. 9, 2012

(30) Foreign Application Priority Data
Sep. 14, 2009 (JP) 2009-212011

(51) Int. Cl. B32B 38/10

(52) U.S. Cl. 156/701; 156/750

(57) ABSTRACT

A delaminating apparatus (1) includes: a delamination stage (3) configured so that an LCD device (30) having an LCD panel is placed thereon; a wire (10) that is placed to extend along an entire outer periphery of a polarizing plate, so that the wire is inserted into a gap formed between the LCD panel and the polarizing plate in four corners of the polarizing plate; and a wire wind-up portion (5) configured to wind up the wire (10) to move the wire (10). By winding up the wire (10), the polarizing plate is separated from the LCD panel while moving the wire (10) between the polarizing plate and the LCD panel, whereby the polarizing plate is delaminated from the LCD panel.

### TECHNICAL FIELD

The present invention relates to apparatuses and methods for delaminating an adhesive film, and more particularly to techniques of delaminating a polarizing plate bonded to a liquid crystal display (LCD) panel.

### BACKGROUND ART

An optical film such as a retarder or a polarizing plate is sometimes bonded to the surface of a display panel. For example, a polarizing plate etc. is bonded to an LCD panel to control liquid crystal by using the function of liquid crystal.

The LCD panel is includes a TFT substrate having thin film transistors (TFTs) etc. formed on a glass substrate, a CF substrate having a color filter (CF) etc. formed on a glass substrate, and a liquid crystal layer enclosed between the TFT substrate and the CF substrate. The TFT substrate is bonded to the CF substrate by a frame-shaped sealant interposed therebetween, and the liquid crystal layer is sealed between these substrates by the sealant.

The LCD panel needs to use light that oscillates only in a predetermined direction, and a polarizing plate configured to allow the light that oscillates only in the predetermined direction to transmit therethrough is bonded to the surface of the LCD panel. More specifically, polarizing plates as films are bonded to those surfaces of the TFT substrate and the CF substrate which are located on the opposite side from the liquid crystal layer, via adhesive layers, respectively.

In manufacturing of LCD devices, an inspection step, such as inspection of appearance and turn-on inspection, is performed after polarizing plates are attached to LCD panels. If any abnormal condition, such as foreign matter caught between the polarizing plate and the panel surface or a shift of the bonding position of the polarizing plate on the panel surface, is detected in this inspection step, it is necessary to delaminate the abnormal polarizing plate from the LCD panel, and then to bond a normal polarizing plate to the LCD panel.

Thus, a method for delaminating such a polarizing plate has been proposed. More specifically, a method for delaminating, e.g., an adhesive film (a polarizing plate) from a bonding surface of a target object (an LCD panel), namely an object from which the adhesion film is to be delaminated, has been disclosed. In this method, a part of the adhesive film, which is located in one corner of the bonding surface of the target object, is first separated from the bonding surface of the target object, and then the adhesive film is wound up and delaminated while holding the separated part of the adhesive film and rotating it in a delamination direction at a constant rotational speed. It is described that this method allows the adhesive film to be delaminated from the target object at a constant delamination speed regardless of the adhesion strength between the bonding surface of the target object and the adhesive film, and thus allows the adhesive film to be easily delaminated from the target object even if the adhesion strength between the bonding surface of the target object and the adhesive film is high (see, e.g., Patent Document 1).

Similarly, another method for delaminating an adhesive film has been disclosed in which a part of an adhesive film (a polarizing plate), which is located in one corner of a bonding surface of a target object (an LCD panel), is separated from the bonding surface of the target object, the adhesive film is wound up by a predetermined number of turns onto a wind-up roller from the delaminated part of the adhesive film, and then the adhesive film is pulled and delaminated while moving the wind-up roller in a delamination direction. It is described that this method allows the delaminated adhesive film such as a polarizing plate to be easily collected (see, e.g., Patent Document 2).

### CITATION LIST

### Patent Documents

PATENT DOCUMENT 1: Japanese Patent Publication No. H08-292433
PATENT DOCUMENT 2: Japanese Patent Publication No. 2006-299064

### SUMMARY OF THE INVENTION

### Technical Problem

However, in the above conventional delamination methods, the polarizing plate is pulled and delaminated from the LCD panel while winding up the polarizing plate. Thus, as shown in FIG. 13, the polarizing-plate delamination interface of the LCD panel 51 is subjected to a stress (i.e., a tensile force applied to an LCD panel 51 due to a force “f₁” with which a polarizing plate 50 is delaminated) “f₂” in a thickness direction “T” of the LCD panel 51 when the polarizing plate 50 is wound up. This stress “f₁” can deform the LCD panel 51 or break a glass substrate of the LCD panel 51, thereby damaging the LCD panel 51. In particular, if the adhesion strength between the polarizing plate 50 and the LCD panel 51 is high, the force “f₁” with which the polarizing plate 50 is delaminated is increased, and thus the stress “f₂” is also increased, which can cause significant damage to the LCD panel 51.

Moreover, the configuration of winding up the LCD panel 51 can deform or damage the polarizing plate 50.

The present invention was developed in view of the above problems, and it is an object of the present invention to provide an apparatus and a method for delaminating an adhesive film, which are capable of effectively suppressing deformation or damage to the adhesive film such as a polarizing plate and a target object having the adhesive film such as an LCD panel.

### Solution to the Problem

In order to achieve the above object, an apparatus for delaminating an adhesive film according to the present invention includes: a delamination stage configured so that a target object having the adhesive film bonded to a surface of a substrate via an adhesive layer is placed thereon; and a wire that is placed to extend along an entire outer periphery of the adhesive film so that the wire is inserted into a gap formed between the substrate and the adhesive film in four corners of the adhesive film. The apparatus according to the present invention further includes: a wire wind-up portion configured to wind up the wire to move the wire; a drive portion configured to drive the wire wind-up portion; and a control portion configured to control the drive portion. The control portion controls the drive portion so that the wire wind-up portion winds up the wire in order to delaminate the adhesive film from the substrate by separating the adhesive film from the substrate while moving the wire between the adhesive film and the substrate.

With the above configuration, the adhesive film can be delaminated by the wire being wound up, without subjecting an adhesive-film delamination interface of the substrate to a stress in a thickness direction of the substrate. This can prevent deformation or damage to the target object due to the stress. Since the adhesive film is not wound up, the adhesive film can be delaminated without being deformed, and damage to the adhesive film can be prevented.

In the apparatus of the present invention, the control portion may control the drive portion so that a moving speed of the wire when winding up the wire is in a range of 0.05 mm/sec to 1.80 mm/sec, both inclusive.

With the above configuration, the moving speed of the wire can be adjusted to a desired low moving speed. Thus, the timing of destroying the adhesive layer can be controlled according to adhesion strength of the adhesive film, and delamination resistance can be reduced.

In the apparatus of the present invention, the wire may be a thin wire.

With the above configuration, the delamination resistance can be flexibly distributed in an arc shape regardless of the material and the composition state of the wire. Moreover, the same wire can be repeatedly used until it breaks.

In the apparatus of the present invention, the wire may have a diameter in a range of 0.1 mm to 0.5 mm, both inclusive.

With the above configuration, the adhesive film can be safely and reliably delaminated even if the gap between the substrate and the adhesive film is narrow.

The apparatus of the present invention has an excellent property in which the adhesive film can be delaminated without causing deformation or damage to the target object having the adhesive film bonded thereto. Thus, the apparatus of the present invention is preferably used in the case where the substrate is a glass substrate of an LCD panel and the adhesive film is a polarizing plate.

A method for delaminating an adhesive film according to the present invention is a method for delaminating an adhesive film bonded to a surface of a substrate via an adhesive layer. The method of the present invention includes the step of separating the adhesive film from the substrate in four corners of the adhesive film, and forming a gap between the substrate and the adhesive film in the four corners of the adhesive film. The method of the present invention further includes at least the steps of: placing a wire so that the wire extends along an entire outer periphery of the adhesive film, and inserting the wire into the gap in the four corners of the adhesive film; and winding up the wire to separate the adhesive film from the substrate while moving the wire between the adhesive film and the substrate, thereby delaminating the adhesive film from the substrate.

With the above configuration, the adhesive film can be delaminated by the wire being wound up, without subjecting an adhesive-film delamination interface of the substrate to a stress in a thickness direction of the substrate. This can prevent deformation or damage to the target object due to the stress. Since the adhesive film is not wound up, the adhesive film can be delaminated without being deformed, and damage to the adhesive film can be prevented.

In the method of the present invention, a moving speed of the wire when winding up the wire may be in a range of 0.05 mm/sec to 1.80 mm/sec, both inclusive.

With the above configuration, the moving speed of the wire can be adjusted to a desired low moving speed. Thus, the timing of destroying the adhesive layer can be controlled according to adhesion strength of the adhesive film, and delamination resistance can be reduced.

In the method of the present invention, the wire may be a thin wire.

With the above configuration, the delamination resistance can be flexibly distributed in an arc shape regardless of the material and the composition state of the wire. Moreover, the same wire can be repeatedly used until it breaks.

In the method of the present invention, the wire may have a diameter in a range of 0.1 mm to 0.5 mm, both inclusive.

With the above configuration, the adhesive film can be safely and reliably delaminated even if the gap between the substrate and the adhesive film is narrow.

The method of the present invention has an excellent property in which the adhesive film can be delaminated without causing deformation or damage to the target object having the adhesive film bonded thereto. Thus, the method of the present invention is preferably used in the case where the substrate is a glass substrate of an LCD panel and the adhesive film is a polarizing plate.

### Advantages of the Invention

The present invention allows an adhesive film to be delaminated from a target object having the adhesive film bonded thereto, without causing deformation or damage to the target object.

### BRIEF DESCRIPTION OF THE DRAWINGS

FIG. 1 is a perspective view showing the overall configuration of a polarizing-plate delaminating apparatus according to an embodiment of the present invention.

FIG. 2 is a plan view showing the configuration of a wire fixing portion in the polarizing-plate delaminating apparatus according to the embodiment of the present invention.

FIG. 3 is a perspective view showing the configuration of a wire wind-up portion in the polarizing-plate delaminating apparatus according to the embodiment of the present invention.

FIG. 4 is a cross-sectional view showing a wire in the polarizing-plate delaminating apparatus according to the embodiment of the present invention.

FIG. 5 is a cross-sectional view showing the configuration of an LCD device including an LCD panel as a target object.

FIG. 6 is a cross-sectional view showing the configuration of a polarizing plate as an adhesive film.

FIG. 7 is a diagram illustrating a method for delaminating a polarizing plate according to the embodiment of the present invention.

FIG. 8 is a diagram illustrating the method for delaminating a polarizing plate according to the embodiment of the present invention.

FIG. 9 is a diagram illustrating the method for delaminating a polarizing plate according to the embodiment of the present invention.

FIG. 10 is a diagram illustrating the method for delaminating a polarizing plate according to the embodiment of the present invention.

FIG. 11 is a diagram illustrating the method for delaminating a polarizing plate according to the embodiment of the present invention.

FIG. 12 is a diagram illustrating the method for delaminating a polarizing plate according to the embodiment of the present invention.

FIG. 13 is a cross-sectional view illustrating a conventional method for delaminating a polarizing plate.

### DESCRIPTION OF EMBODIMENTS

An embodiment of the present invention will be described in detail below with reference to the accompanying drawings. Note that the present invention is not limited to the following embodiment.

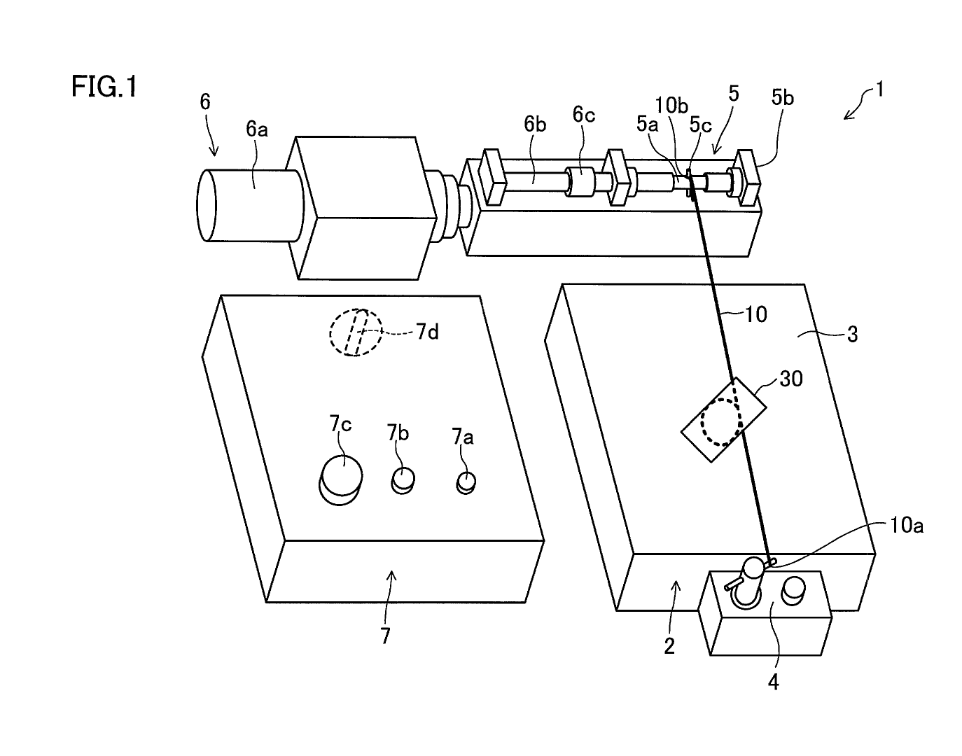

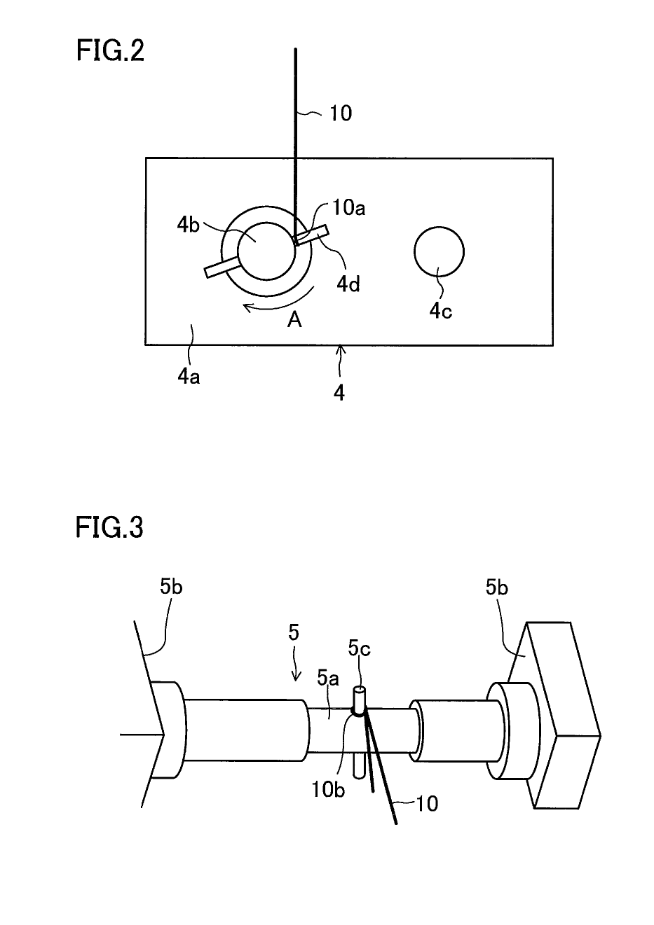

FIG. 1 is a perspective view showing the overall configuration of a polarizing-plate delaminating apparatus according to an embodiment of the present invention. FIG. 2 is a plan view showing the configuration of a wire fixing portion in the polarizing-plate delaminating apparatus according to the embodiment of the present invention. FIG. 3 is a perspective view showing the configuration of a wire wind-up portion in the polarizing-plate delaminating apparatus according to the embodiment of the present invention.

As shown in FIG. 1, the delaminating apparatus 1 includes: a base portion 2 in the shape of a rectangular parallelepiped; a delamination stage 3 provided on the upper surface of the base portion 2 and configured so that an LCD device 30 is placed thereon; and a wire fixing portion 4 provided so as to adjoin the delamination stage 3 and configured to fix a wire 10 used to delaminate a polarizing plate. The delaminating apparatus 1 further includes a wire wind-up portion 5 provided so as to face the wire fixing portion 4 with the delamination stage 3 interposed therebetween, having the wire 10 fixed thereto, and configured to wind up the wire 10 to move the wire 10, and a drive portion 6 provided so as to adjoin the wire wind-up portion 5 and configured to drive the wire wind-up portion 5. The delaminating apparatus 5 further includes a control portion 7 provided so as to adjoin the drive portion 6 and configured to control the drive portion 6.

As shown in FIG. 2, the wire fixing portion 4 includes a base portion 4a as a main body, a sagging absorbing portion 4b provided on the surface of the base portion 4a and configured to absorb sagging of the wire 10, and a release button 4c provided so as to adjoin the sagging absorbing portion 4b and configured to release the sagging absorbing portion 4b from a fixed state. The sagging absorbing portion 4b is provided with a latch portion 4d configured to latch the wire 10. The wire 10 is fixed to the sagging absorbing portion 4b by latching one end 10a of the wire 10 on the latch portion 4d.

As shown in FIG. 3, the wire wind-up portion 5 includes a roller 5a as a rotating member, and a support member 5b configured to rotatably support the roller 5a. The roller 5a is provided with a latch portion 5c configured to latch the wire 10. The wire 10 is fixed to the roller 5a by latching the other end 10b of the wire 10 on the latch portion 5c.

A motor is used as the drive portion 6 configured to drive the wire wind-up portion 5. As shown in FIG. 1, the drive portion 6 includes a motor main body 6a, a rotating shaft 6b extending from the motor main body 6a toward the wire wind-up portion 5, and a torque limiter 6c attached to the rotating shaft 6b. The roller 5a of the wire wind-up portion 5 is configured to be connected to the rotating shaft 6b of the motor via the torque limiter 6c.

The control portion 7 is connected to the drive portion 6, and is configured to control the drive portion 6. As shown in FIG. 1, the control portion 7 includes a power button 7a configured to turn on/off the drive portion 6, a start button 7b configured to start operation of the drive portion 6, and a stop button 7c configured to stop operation of the drive portion 6. As shown in FIG. 1, the control portion 7 includes an adjusting member 7d on its side surface located on the side of the drive portion 6. The adjusting member 7d is configured to adjust the wind-up speed of the wire 10 by the wire wind-up portion 5 (that is, the rotational speed of the rotating shaft 6b of the drive portion 6 having the roller 5a of the wire wind-up portion 5 connected thereto). The adjusting member 7d is a pivotable member, and is configured to be pivoted to adjust the wind-up speed of the wire 10.

The wire 10 is a deformable wire. Although the material of the wire 10 is not particularly limited, the wire 10 may be comprised of, e.g., a thin wire such as a metal wire like a piano wire, a resin wire like Dyneema that is used for fishing lines etc. By using such a wire, the delamination resistance can be distributed in an arc shape. Moreover, the same wire can be repeatedly used until it breaks.

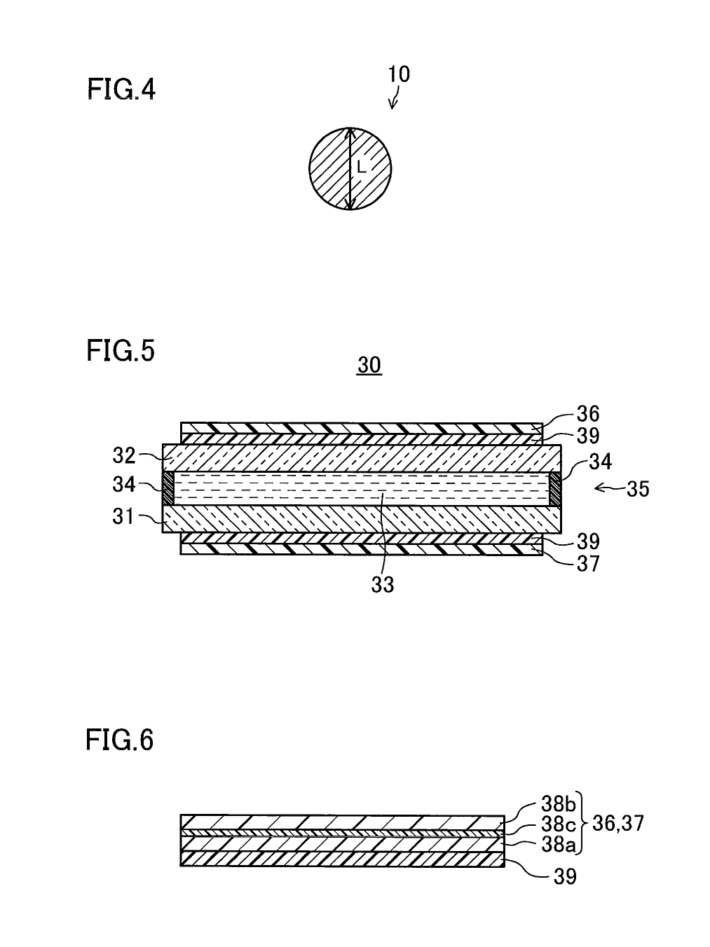

Although the diameter “L” of the wire 10 shown in FIG. 4 is not particularly limited, the diameter “L” is preferably in the range of 0.1 mm to 0.5 mm, both inclusive. If the diameter “L” is less than 0.1 mm, the tensile strength of the wire with respect to the delamination resistance of the polarizing plate is reduced, and the wire may break during delamination. If the diameter “L” is more than 0.5 mm, the delamination resistance increases due to a wider gap between the polarizing plate and the CF substrate (or the TFT substrate), which may cause damage such as bending of the polarizing plate. In other words, if the diameter “L” of the wire 10 is 0.5 mm or less, the polarizing plate is delaminated at a smaller angle, and thus the resistance during delamination of the polarizing plate can be reduced, whereby the polarizing plate can be more safely delaminated. That is, using the wire 10 having the diameter “L” in the range of 0.1 nm to 0.5 mm, both inclusive, allows the polarizing plate to be safely and reliably delaminated from the substrate without causing disadvantages such as breakage of the wire or bending of the polarizing plate, even if the gap between the polarizing plate and the CF substrate (or the TFT substrate) is narrow. The length of the wire 10 is not particularly limited, and the wire 10 having any length can be used as appropriate according to the area of the LCD device 30.

An example of a method for delaminating a polarizing plate bonded to an LCD panel by using the polarizing-plate delaminating apparatus 1 having the above configuration will be described below. FIG. 5 is a cross-sectional view showing the configuration of an LCD device including an LCD panel as a target object. FIG. 6 is a cross-sectional view showing the configuration of a polarizing plate as an adhesive film.

First, the LCD device will be described. As shown in FIG. 5, the LCD device 30 includes an LCD panel 35 as a target object, and polarizing plates 36, 37 as adhesive films bonded to the LCD panel 35.

The LCD panel 35 includes a TFT substrate 31 (thickness: about 0.20 mm) as a first substrate, and a CF substrate 32 (thickness: about 0.10 mm) as a second substrate facing the TFT substrate 31. The LCD panel 35 further includes a liquid crystal layer 33 as a display medium layer provided between the TFT substrate 31 and the CF substrate 32, and a sealant 34 provided in a frame shape in order to bond the TFT substrate 31 to the CF substrate 32, and to enclose the liquid crystal layer 33 therebetween. The sealant 34 is formed so as to surround the liquid crystal layer 33, and the TFT substrate 31 is bonded to the CF substrate 32 via the sealant 34. Each of the TFT substrate 31 and the CF substrate 32 is comprised of a glass substrate.

As shown in FIG. 5, the polarizing plates 36, 37 are placed so as to face each other. As shown in FIG. 6, each of the polarizing plates 36, 37 includes: a pair of support bodies 38a, 38b each comprised of a triacetylcellulose film etc.; a polarizing element layer 38c provided between the support bodies 38a, 38b and including a polarizing element, which is comprised of a polyvinyl alcohol film stained with iodine etc. and has a polarization axis in one direction; and a transparent protective film (not shown) provided on the surface of the other support body 38b.

Each of the polarizing plates 36, 37 is provided with an adhesive layer 39, which is provided on the surface of one support body 38a and configured to bond the polarizing plate 36, 37 to the surface of the TFT substrate 31 or the CF substrate 32. That is, in the LCD panel 35 as a target object, the polarizing plates 36, 37 as adhesive films are bonded to the surface of the TFT substrate 31 and the surface of the CF substrate 32 via the adhesive layers 39, respectively.

The adhesive layer 39 is comprised of e.g., an acrylic adhesive polymerized with butylacrylate, and has viscoelasticity of 16,000 Pa at 75° C. The polarizing plate 36, 37 has a size of, e.g., 140 nm by 230 nm.

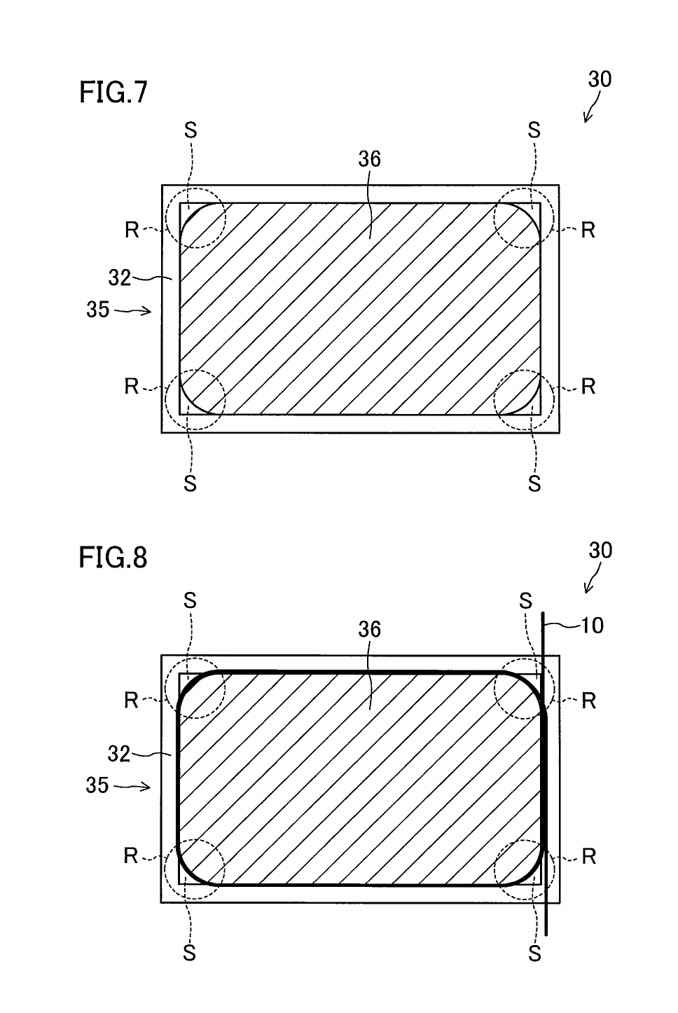

The method for delaminating the polarizing plate will be specifically described below. FIGS. 7-12 are diagrams illustrating the method for delaminating the polarizing plate according to the embodiment of the present invention. Although there are two polarizing plates 36, 37, a method for delaminating the polarizing plate 36 bonded to the surface of the CF substrate 32 will be described below as an example.

First, as shown in FIG. 7, the polarizing plate 36 is separated from the LCD panel 35 (i.e., the CF substrate 32) in four corners “R” of the polarizing plate 36 to form a gap “S” between the LCD panel 35 (i.e., the CF substrate 32) and the polarizing plate 36 in each of the four corners “R.”

More specifically, the tip of a blade (not shown), a thin metal sheet, etc. is first brought into contact with the surface of the CF substrate 32 at a position located outside the peripheral end of the polarizing plate 36. Then, the tip of the blade is moved along the surface of the CF substrate 32 to insert the blade between the CF substrate 32 and the polarizing plate 36, thereby forming the gap “S” between the CF substrate 32 and the polarizing plate 36 in each of the four corners R.

Next, the LCD device 30 (i.e., the LCD panel 35 as a target object) having the gaps “S” formed therein is placed on the delamination stage 3. In the present embodiment, the LCD device 30 placed on the delamination stage 3 need not be fixed.

Then, the other end 10b of the wire 10 is latched on the latch portion 5c provided on the roller 5a of the wire wind-up portion 5, thereby fixing the wire 10 to the roller 5a.

Thereafter, as shown in FIG. 8, the wire 10 is placed to extend along the entire outer periphery of the polarizing plate 36, and is inserted into the gaps “S” in the four corners R of the polarizing plate 36. At this time, as shown in FIG. 8, the wire 10 is made to cross itself in one of the four corners “R” of the polarizing plate 36.

Subsequently, with the wire 10 being inserted in the gaps “S” in the four corners R of the polarizing plate 36, the one end 10a of the wire 10 is latched on the latch portion 4d provided in the sagging absorbing portion 4b of the wire fixing portion 4, thereby fixing the wire 10 to the sagging absorbing portion 4b.

Then, the sagging absorbing portion 4b is rotated in the direction of arrow “A” shown in FIG. 2 to eliminate sagging of the wire 10.

Thereafter, the power button 7a provided in the control portion 7 is depressed to turn on the motor as the drive portion 6.

Thus, winding-up of the wire 10 is started, and delamination of the polarizing plate 36 is started.

At this time, in the present embodiment, the polarizing plate 36 can be delaminated by the wire 10 being wound up, without subjecting the polarizing-plate delamination interface of the CF substrate 32 to a stress in the thickness direction of the CF substrate 32.

More specifically, if the winding-up of the wire 10 is started from the state of FIG. 8, a force “F₁” with which the wire 10 is wound up changes into a force “F₂” with which the wire 10 moves toward the center “O” of a circle “C” formed by the wire 10. Thus, the wire 10 moves toward the center “O” of the circle “C.”

At this time, as shown in FIG. 10, the wire 10 moving toward the center “O” of the circle “C” (that is, moving in the directions of arrows “X,” “Y” shown in FIG. 10) enters the gap between the LCD panel 35 and the polarizing plate 36 closely adhering to the LCD panel 35. Thus, the wire 10 gradually delaminates the polarizing plate 36 from the LCD panel 35 while forming gaps “D” between the polarizing plate 36 and the LCD panel 35. Each of the gaps “D” has the same size as the diameter “L” of the wire 10.

In the present embodiment, since each of a force “F₃” with which the wire 10 moving in the direction of arrow “X” delaminates the polarizing plate 36 and a force “F₄” with which the wire 10 moving in the direction of arrow “Y” delaminates the polarizing plate 36, as shown in FIG. 10, is equal to the force “F₂” with which the wire 10 moves toward the center “O” of the circle “C” (i.e., F₂=F₃=F₄), the force “F₃” is canceled by the force “F₄.” Thus, unlike the above conventional methods involving winding-up of a polarizing plate, the delamination interface between the CF substrate 32 and the polarizing plate 36 is not subjected to a stress in the thickness direction T of the LCD panel 35 when the polarizing plate 36 is delaminated. This can prevent deformation or damage to the LCD panel 35 due to the stress.

As described above, in the present embodiment, the LCD device 30 placed on the delamination stage 3 need not be fixed. This is because the force “F₄” serves as a force with which the LCD device 30 is fixed when the polarizing plate 36 is delaminated by the wire 10.

The wind-up speed (the moving speed) of the wire 10, namely the speed at which the wire 10 is wound up (moved), is preferably in the range of 0.05 mm/sec to 1.80 mm/sec, both inclusive. If the wind-up speed is lower than 0.05 mm/sec, rotation and torque of the motor may be destabilized due to the low wind-up speed, and the time it takes to delaminate the polarizing plate 36 may be excessively increased. If the wind-up speed is higher than 1.80 mm/sec, the moving speed of the wire 10 becomes higher with respect to the timing the adhesive layer 39 between the polarizing plate 36 and the CF substrate 32 is destroyed. This tends to cause bending of the polarizing plate 36 etc., making it difficult to normally delaminate the polarizing plate 36. That is, using the wind-up speed (the moving speed) of the wire 10 in the range of 0.05 mm/sec to 1.80 mm/sec, both inclusive, allows the moving speed of the wire 10 to be adjusted to a desired low moving speed. Thus, the timing of destroying the adhesive layer 39 can be controlled according to the adhesion strength of the polarizing plate 36, and the delamination resistance can be reduced.

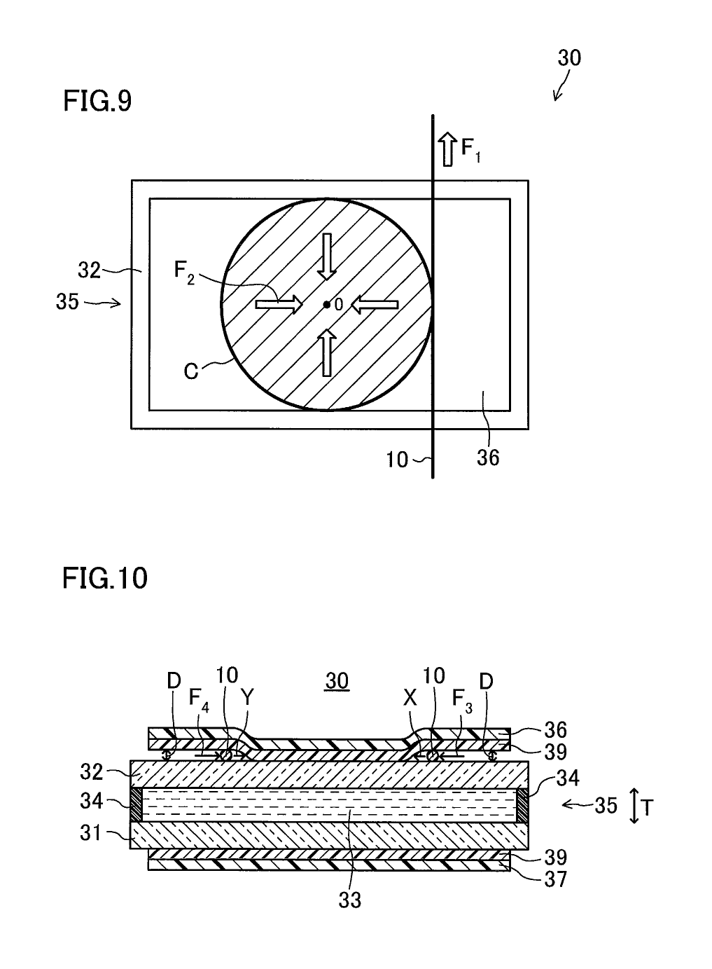

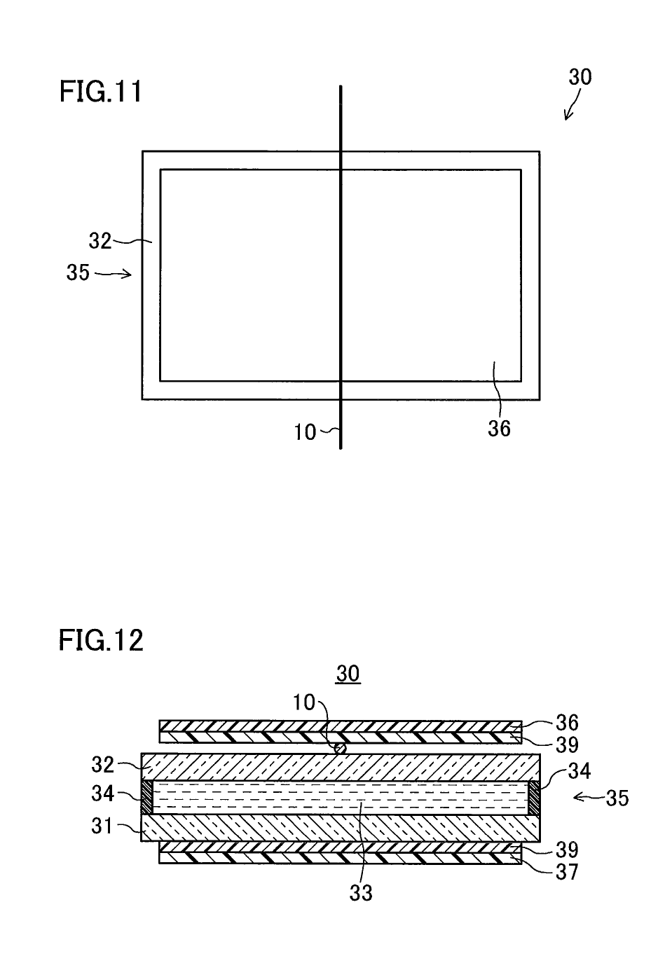

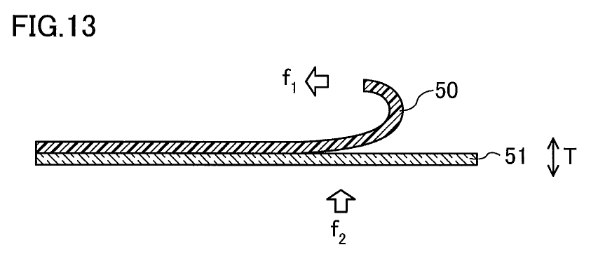

Then, as the wire 10 is further wound up from the state of FIGS. 9-10, the wire 10 between the polarizing plate 36 and the LCD panel 35 further moves toward the center “O” of the circle “C” while forming the gaps “D” between the polarizing plate 36 and the LCD panel 35, whereby the polarizing plate 36 is further separated from the LCD panel 35. Then, as shown in FIGS. 11-12, the wire 10 is finally brought into in a linear state, and the polarizing plate 36 is completely separated from the LCD panel 35. The polarizing plate 36 is located above the wire 10, and the LCD panel 5 is located below the wire 10.

That is, in the present embodiment, the control portion 7 is configured to control the drive portion 6 so that the wire wind-up portion 5 winds up the wire 10 in order to delaminate the polarizing plate 36 from the CF substrate 32 by separating the polarizing plate 36 from the CF substrate 32 while moving the wire 10 between the polarizing plate 36 and the CF substrate 32 of the LCD panel 35.

At this time, since the polarizing plate 36 is not wound up as in the above related art, the polarizing plate 36 can be delaminated without being deformed as shown in FIGS. 11-12, and damage to the polarizing plate 36 can be prevented.

Then, the stop button 7c provided in the control portion 7 is depressed to turn off the motor as the drive portion 6, whereby winding-up of the wire 10 is terminated.

Thereafter, as in the delamination of the polarizing plate 36 described above, the polarizing plate 37 is delaminated from the LCD panel 35 (i.e., the TFT substrate 31) by using the wire 10.

The polarizing plates 36, 37 can be delaminated from the LCD panel 35 in this manner.

The following advantages can be obtained by the present embodiment described above.

In the present embodiment, the wire 10 is placed to extend along the entire outer periphery of the polarizing plate 36, so that the wire 10 is inserted into the gaps “S” formed between the CF substrate 32 and the polarizing plate 36 in the four corners R of the polarizing plate 36. Moreover, the polarizing plate 36 is delaminated from the CF substrate 32 by separating the polarizing plate 36 from the CF substrate 32 while moving the wire 10 between the polarizing plate 36 and the CF substrate 32 by winding up the wire 10. This configuration allows the polarizing plate 36 to be delaminated by the wire 10 being wound up, without subjecting the polarizing-plate delamination interface of the CF substrate 32 to a stress in the thickness direction (that is, the thickness direction “T” of the LCD panel 35) of the CF substrate 32. This can prevent deformation or damage to the LCD panel 35 due to the stress. Moreover, since the polarizing plate 36 is not wound up, the polarizing plate 36 can be delaminated without being deformed, and damage to the polarizing plate 36 can be prevented.

In the present embodiment, the moving speed of the wire 10 when winding up the wire 10 is in the range of 0.05 mm/sec to 1.80 mm/sec, both inclusive. This configuration allows the moving speed of the wire 10 to be adjusted to a desired low moving speed. Thus, the timing of destroying the adhesive layer 39 can be controlled according to the adhesion strength of the polarizing plate 36, and the delamination resistance can be reduced.

In the present embodiment, a thin wire is used as the wire 10. This configuration allows the delamination resistance to be flexibly distributed in an arc shape regardless of the material and the composition state of the wire, and also allows the same wire to be repeatedly used until it breaks.

In the present embodiment, the diameter “L” of the wire 10 is in the range of 0.1 mm to 0.5 mm, both inclusive. This configuration allows the polarizing plate 36 to be safely and reliably delaminated without causing disadvantages such as breakage of the wire 10 or bending of the polarizing plate 36, even if the gap between the polarizing plate 36 and the CF substrate 32 is narrow.

The above embodiment may be modified as follows.

The above embodiment is described above with respect to an example in which the LCD panel 35 having the polarizing plates 36, 37 respectively bonded to the surfaces of the TFT substrate 31 and the CF substrate 32 via the adhesive layers 39 is used as a target object. However, the target object to which the present invention is applied is not limited to this. For example, the present embodiment may be used as a separation method in the case where an element that is hard and is easily broken, an element that is easily deformed, etc. has been fixed to a target object by an adhesive or a bonding material. The target object need not necessarily be a planar object. Even if the target object is a curved object, a spherical object, etc., an element can be separated or delaminated from the target object without destroying the target object.

### EXAMPLE

The present invention will be described based on an example and a comparative example. The present invention is not limited to this example, and various modifications and variations can be made without departing from the scope and sprit of the present invention.

### First Example

First, thirty LCD devices, each including an LCD panel and polarizing plates bonded thereto, were prepared. Each of the LCD panels used in this example included a TFT substrate comprised of a glass substrate having a length of 73 mm, a width of 41 mm, and a thickness of 0.2 mm, a CF substrate comprised of a glass substrate having a length of 70 mm, a width of 41 mm, and a thickness of 0.1 mm, a liquid crystal layer provided between the TFT substrate and the CF substrate and having a thickness of 4 vim, and a sealant provided in a frame shape in order to enclose the liquid crystal layer. Each of the polarizing plates used in the first example had an adhesive layer provided on its surface, and had a length of 69 mm, a width of 41 mm, and a thickness of 0.2 mm.

Next, in each of the LCD devices, the polarizing plate was delaminated by using the polarizing-plate delaminating apparatus shown in FIG. 1. A wire comprised of a resin thread and having a diameter of 0.23 nm was used in this example. The wind-up speed of the wire was 0.5 mm/sec.

Then, each of the LCD panels after delamination of the polarizing plates was visually examined for damage. It was determined that the LCD panel had been damaged, if there was any fracture (crack) in the LCD panel after delamination of the polarizing plates.

As a result, in this example, no damage was observed in any of the LCD panels after delamination of the polarizing plates, and the polarizing plates were able to be delaminated without damaging the LCD panels.

### Comparative Example

First, ten LCD devices, each including an LCD panel and polarizing plates bonded thereto, were prepared in a manner similar to that of the first example.

Next, in each of the LCD devices, the polarizing plate was delaminated by separating the polarizing plate in one corner from the bonding surface of the LCD panel, and winding up the polarizing plate while holding the separated part of the polarizing plate and rotating it in the delamination direction at a rotational speed of 0.5 mm/sec.

Then, as in the first example, each of the LCD panels after delamination of the polarizing plates was visually examined for damage.

As a result, in this comparative example, damage was observed in all of the ten LCD panels after delamination of the polarizing plates.

### INDUSTRIAL APPLICABILITY

As described above, the present invention relates to apparatuses and methods for delaminating an adhesive film, and is especially suitable for apparatuses and methods for delaminating a polarizing plate bonded to an LCD panel.

### DESCRIPTION OF REFERENCE CHARACTERS

1 Delaminating Apparatus
2 Base Portion
3 Delamination Stage
4 Wire Fixing Portion
5 Wire Wind-Up Portion
6 Drive Portion
7 Control Portion
10 Wire
30 LCD Device
31 TFT Substrate
32 CF Substrate
35 LCD Panel (Target Object)
36 Polarizing Plate (Adhesive Film)
37 Polarizing Plate (Adhesive Film)
39 Adhesive Layer
R Wire Diameter

1. An apparatus for delaminating an adhesive film, comprising:
a delamination stage configured so that a target object having the adhesive film bonded to a surface of a substrate via an adhesive layer is placed thereon;
a wire that is placed to extend along an entire outer periphery of the adhesive film, so that the wire is inserted into a gap formed between the substrate and the adhesive film in four corners of the adhesive film;
a wire wind-up portion configured to wind up the wire to move the wire;
a drive portion configured to drive the wire wind-up portion; and
a control portion configured to control the drive portion, wherein
the control portion controls the drive portion so that the wire wind-up portion winds up the wire in order to delaminate the adhesive film from the substrate by separating the adhesive film from the substrate while moving the wire between the adhesive film and the substrate.

2. The apparatus of claim 1, wherein
the control portion controls the drive portion so that a moving speed of the wire when winding up the wire is in a range of 0.05 mm/sec to 1.80 mm/sec, both inclusive.

3. The apparatus of claim 1, wherein
the wire is a thin wire.

4. The apparatus of claim 1, wherein
the wire has a diameter in a range of 0.1 mm to 0.5 mm, both inclusive.

5. The apparatus of claim 1, wherein
the substrate is a glass substrate of an LCD panel, and the adhesive film is a polarizing plate.

6. A method for delaminating an adhesive film bonded to a surface of a substrate via an adhesive layer, comprising at least the steps of:
separating the adhesive film from the substrate in four corners of the adhesive film, and forming a gap between the substrate and the adhesive film in the four corners of the adhesive film;
placing a wire so that the wire extends along an entire outer periphery of the adhesive film, and inserting the wire into the gap in the four corners of the adhesive film; and
winding up the wire to separate the adhesive film from the substrate while moving the wire between the adhesive film and the substrate, thereby delaminating the adhesive film from the substrate.

7. The method of claim 6, wherein
a moving speed of the wire when winding up the wire is in a range of 0.05 mm/sec to 1.80 mm/sec, both inclusive.

8. The method of claim 6, wherein
the wire is a thin wire.

9. The method of claim 6, wherein
the wire has a diameter in a range of 0.1 mm to 0.5 mm, both inclusive.

10. The method of claim 6, wherein
the substrate is a glass substrate of an LCD panel, and the adhesive film is a polarizing plate.
